(19) United States
(12) Patent Application Publication
(10) Pub. No.: US 2011/0055570 A1
(43) Pub. Date: Mar. 3, 2011

(54) LOCATION UPDATE OF A MOBILE NODE

(75) Inventors: Petri Jokela, Espoo (FI); Jan Melen, Espoo (FI); Patrik Salmela, Kirkkonummi (FI); Jukka Ylitalo, Espoo (FI)

(73) Assignee: Telefonaktiebolaget LM Ericsson (publ), Stockholm (SE)

(21) Appl. No.: 12/674,020

(22) PCT Filed: Aug. 22, 2008
(86) PCT No.: PCT/EP08/61050

§ 371 Date: Feb. 18, 2010

(30) Foreign Application Priority Data
Aug. 31, 2007 (GB) 0716823.0

(51) Int. Cl. H04W 36/00; H04W 12/04; H04W 12/06; H04L 9/32

(52) U.S. Cl. 713/171; 455/456.1; 455/411

(57) ABSTRACT

A method of facilitating location update signalling within a communication network between a mobile node and an end host includes establishing a trust relationship between one or more end hosts (1) and a proxy (3). When a mobile node (2) is handed-off, a location update is performed between the mobile node (2) and the proxy (3), and a location update message is sent from the proxy to the end host(s) having the trust relationship with the proxy. Multiple end hosts may authorise the same proxy to perform location update signalling on their behalf. The number of signalling messages required to perform the location update may be reduced, compared to a legacy method in which the mobile node is required to perform location update signalling with each end host.

### FIELD

The present invention relates to method of location update for a mobile node.

### BACKGROUND

As is known, a mobile host may connect to a fixed communication network via one of a plurality of access points. Each access point has a defined area of geographic coverage and, as the mobile host moves, it is transferred from one access point to another when it passes from a geographic area served by one access point to the geographic area served by another access point. This process is referred to as “hand-off”. The mobile host may be a mobile consumer device such as a mobile telephone, a laptop computer, a Personal Digital Assistant etc.

It is desirable that the user of the mobile host does not experience any breakdown or interruption in communication when the mobile node is handed-off from one access point to another, and this requires that, when the mobile host is handed-off from one access point to another, other hosts are made aware of the new access point for the mobile host. Accordingly, when a mobile host is handed-off it sends a location update message to other hosts to inform them of its new location.

FIG. 1 illustrates a conventional hand-off process for a mobile host. When the mobile host 2 changes its attachment to the network it informs its peer hosts 1 about its new location, by sending a location update message advising its new location (step 1). The mobile host 2 sends a location update message to each of the peer hosts 1—that is, the mobile host performs step 1 as many times as there are peer hosts.

When a peer host receives a location update message it must verify that the mobile host is in the new location claimed in the location update message. If this is not done, the mobility protocol would become vulnerable to re-direction and Denial-of-Service (DoS) attacks.

In the hand-off process of FIG. 1, therefore, each peer host carries out a reachability test on the new location claimed in the location update message that the peer host has received. The one round-trip reachability test shown in FIG. 1 is based on a reachability challenge message that is sent to the new location of the mobile host claimed in the location update message (step 2). If the mobile host is in that location it replies to the reachability challenge by sending a response back to the peer host (step 3). Receipt of the response at the peer host indicates that the location update message was genuine, and the peer host may then communicate with the mobile host at the new location claimed in the location update message (as shown schematically in FIG. 1 by the transfer of payload data between the mobile host and the peer hosts). Steps 2 and 3 are performed as many times as there are peer hosts.

If, however, a peer host sends the reachability challenge to the new location of the mobile host claimed in the location update message but does not receive a satisfactory response, this indicates that the location update message may not have been genuine. The peer host may then choose to disregard the location update message.

The method of FIG. 1 illustrates the signalling required in the case of a mobile host. It is also known to use a mobile router to provide network mobility, with messages from the mobile host to the peer host being sent via the mobile router. In such a case the mobile router may also undergo a hand-off as it passes from a geographic area served by one access point to the geographic area served by another access point. On hand-off, the mobile router must exchange three signalling messages with each peer host, in a similar exchange of messages to that shown in FIG. 1.

### SUMMARY

A first aspect of the present invention provides a method of facilitating location update signalling within a communication network between a mobile node and an end host, the method comprising the steps of:

a) establishing a trust relationship between one or more end hosts and a proxy;

b) performing a location update between a mobile node and the proxy; and

c) sending a location update message from the proxy to end host(s) having the trust relationship with the proxy.

It can be seen that the conventional hand-off process of FIG. 1 requires each end host to perform a reachability test with the mobile host. This requires the mobile host and each end host to exchanges three messages—the location update message, the reachability challenge and the response to the challenge. The total number N of messages required to update the location of the mobile host at each end host is therefore N=3×Number of end hosts. Many mobile consumer devices have limited battery power, owing to consumer pressure to reduce the size and weight of consumer devices. It is therefore desirable to reduce the number of signalling messages required upon hand-off, to reduce the power consumed.

The present invention provides a method in which one or more end hosts authorise a proxy to perform location update signalling on their behalf. A proxy may be authorised by multiple end hosts to perform location update signalling. When a mobile host is handed-off it performs location update signalling, preferably including a reachability test, with the proxy rather than with the one or more end hosts. Upon satisfactory completion of the location update signalling, the proxy sends the new location of the mobile host to the end host(s) that have authorised the proxy—the end host(s) can then exchange data with the mobile host at its new location. The present invention can thus reduce the number of location update signalling messages required since, if multiple end hosts authorise the same proxy, the mobile node is required to communicate with one proxy rather than with multiple end hosts.

The present invention provides the following advantages:
The mobile host needs to run a single location update exchange per proxy, not per end host. Several end hosts can register to the same proxy.
This reduces the (over-the-air) signalling both at the mobile host side and at the end host side.
This reduces the total time required for a hand-off, because the mobile node does not need to process so many messages.

Step (b) may include the proxy performing a reachability test. Step (c) may includes sending the location update message only if the reachability test is concluded successfully.

Step (a) may include the proxy being authorised by the end host(s) to perform a reachability test upon their behalf.

The end host(s) may, before the location update is performed, inform the mobile host about the trust relationship.

The end host(s) may inform the mobile host by performing respective key exchanges with the mobile host.

The end host(s) may provide a public key of the proxy to the mobile host in the key exchanges.

The method may further comprise, before the location update is performed, establishing a security association between the mobile node and the proxy.

The proxy may provide the mobile node with evidence of its authorisation to perform the reachability test.

A second aspect of the invention provides a method of facilitating location update signalling for a mobile node within a communication network, the method comprising the steps of:

a) receiving, at a proxy, authorisation from one or more end hosts to perform location update signalling on their behalf;

b) receiving, at the proxy, a location update message from a mobile node; and

c) sending a location update message from the proxy to the end host(s).

The second aspect relates to the steps performed at the proxy.

The method may further comprise the proxy sending a reachability challenge message to the mobile node. Step (c) may comprises the proxy sending the location update message only if the proxy receives a successful response to the reachability challenge message.

Before step (b), a message may be sent from the proxy to the mobile node to establish a security association between the mobile node and the proxy.

The proxy may, before step (b), send to the mobile node evidence of its authorisation to perform a reachability test.

A third aspect of the present invention provides a method of facilitating location update signalling for a mobile node within a communication network, the method comprising the steps of:

a) transmitting, from an end host to a proxy, authorisation for the proxy to perform location update signalling on behalf of the end host;

b) transmitting, from the end host to a mobile node, a message informing the mobile host of the authorisation of the proxy; and

c) receiving, at the end host, a message from the proxy containing a location update for the mobile node.

The third aspect relates to the steps carried out at the end host.

Step (b) may comprise the peer host transmitting a public key of the proxy to the mobile node.

A fourth aspect of the present invention provides a method of facilitating location update signalling for a mobile node within a communication network, the method comprising the steps of:

a) receiving, at a mobile node, notification from an end host that it has authorised a proxy to perform location update signalling on its behalf; and

b) transmitting a location update message from the mobile node to the proxy.

Subsequent to step (a) but before step (b), the mobile host may initiate a key exchange with the proxy.

The mobile node may be a mobile host, or it may be a mobile router.

A fifth aspect of the present invention provides a proxy for facilitating location update signalling for a mobile node within a communication network, wherein the proxy is adapted to:

a) receive authorisation from one or more end hosts to perform location update signalling on their behalf;

b) receive a location update message from a mobile node; and

c) send, to the end host(s) a message containing a location update for the mobile node.

The proxy may be adapted to send a reachability challenge message to the mobile node, and may be adapted to send the message containing a location update for the mobile node only if a successful response to the reachability challenge message is received.

The proxy may be further adapted to, subsequent to receipt of the authorisation from the end host(s), send a message to the mobile node to establish a security association between the mobile node and the proxy.

The proxy may be further adapted to send, to the mobile node, evidence of its authorisation to perform location update signalling on behalf of the end host(s).

A sixth aspect of the present invention provides an end host adapted to:

a) transmit, to a proxy, authorisation for the proxy to perform location update signalling on behalf of the end host;

b) inform a mobile node of the authorisation of the proxy; and

c) receive a location update message from the proxy containing a location update for the mobile node.

The end host may be adapted to inform the mobile node of the authorisation of the proxy by transmitting a public key of the proxy to the mobile node.

A seventh aspect of the present invention provides a mobile node adapted to:

a) receiving notification from an end host that it has authorised a proxy to perform location update signalling on its behalf; and

b) transmit a location update message to the proxy.

The mobile node may be further adapted to, subsequent to receipt of the notification, initiate a key exchange with the proxy.

### BRIEF DESCRIPTION OF THE DRAWINGS

Preferred embodiments of the present invention will now be described with reference to the accompanying drawings, in which:

FIG. 1 is a schematic illustration of a conventional method of location update signalling;

FIG. 2 is a schematic illustration of a method of location update signalling according to a first embodiment of the present invention;

FIG. 3 is a schematic illustration of a method of location update signalling according to a second embodiment of the present invention;

FIG. 4 illustrates the reduction in signalling messages obtainable by a method of the present invention; and

FIG. 5 is a schematic illustration of a method of location update signalling according to a further embodiment of the present invention.

### DETAILED DESCRIPTION

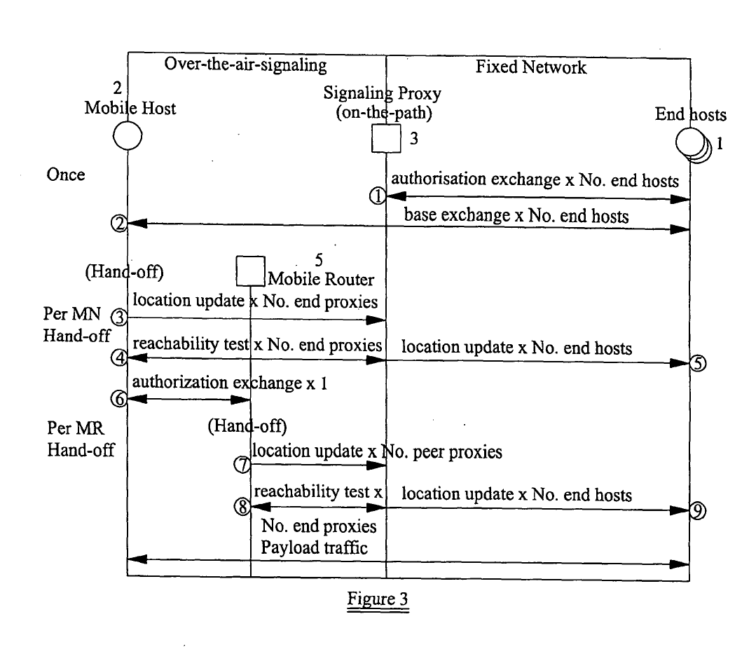

FIG. 2 is a schematic illustration of a method of location update signalling according to an embodiment of the present invention. The method of FIG. 2 allows end hosts to authorise a proxy node (which may be shared between multiple end hosts) to perform location update signalling with a mobile host on behalf of the end host(s) that have authorised the proxy. The end host may be, but is not limited to, a standard end host.

In the method of FIG. 2, an end host 1 authorises a proxy 3 to perform location update signalling on its behalf, and preferably to perform location update signalling that includes a reachability test. The process of the end host 1 authorising the proxy 3 to perform location update signalling establishes a trust domain 4 between the end host 1 and the proxy 3.

The proxy may be, for example, an edge router at an operator's network or any other node that the end host trusts. The proxy 3 may be located, for example, on the border of a service provider so that it can serve a large number of end hosts. The proxy 3 authorised by an end host is not required to be on the end-to-end packet forwarding path between the mobile host and the end host.

The process of an end host 1 authorising a proxy 3 to perform location update signalling on its behalf is shown as step 1 in FIG. 2. In general, the authorisation process of step 1 may require an exchange of messages between the end host 1 and the proxy 3, with the end host 1 authorising the proxy and the proxy 3 sending an acknowledgement message to the end host. The authorisation process may be implemented as, for example, a HIP (Host Identify Protocol) base exchange between the peer host 1 and the proxy 3.

The authorisation process may preferably include the step of the end host sending an authorisation certificate, that shows that the end host has authorised the proxy to perform location update signalling on its behalf, to the proxy 3.

Next in the method of FIG. 2, the end host 1 informs the mobile host 2 that it has authorised the proxy 3 to perform location update signalling on its behalf. This is shown as step 2 in FIG. 2. This step may be implemented as, for example, a key exchange between the end host 1 and the mobile host 2 initiated by the mobile host 2, in which the end host 1 provides the mobile host 2 with a public key of the proxy 3. The key exchange may be implemented, for example, either in 12 packets of HIP or in R2 packets of HIP, depending on which of the hosts initiated the key exchange, by adding a new parameter containing the required proxy information.

Upon completion of step 2, the mobile host 2 knows that end host 1 is behind proxy 3. The mobile host is able to use this information during location update signalling, as is described below.

In the method of FIG. 2, step 1 is performed after the end host 1 connects to the network, and is independent of which mobile hosts may be connected to the network and may wish to communicate with the end host. Step 2 is initiated by the mobile host 2, when the mobile host wishes to communicate with the end host. Step 2 may be performed at different times for different end hosts, depending on when the mobile host wishes to contact each individual end host. After completion of step 2 for a particular end host, the end host becomes a peer host to the mobile host.

When the mobile host 2 receives information about the appointment of a proxy, it initiates an exchange of messages with the proxy and this is shown as step 3 in FIG. 2. The purpose of the exchange of messages at step 3 is to confirm that the proxy 3 does indeed provide proxy service, and so avoid a possible attack in which a peer host provides the address of a “victim node” to a mobile host.

The messages in step 3 may be implemented as a HIP base exchange between the mobile host 2 and the proxy 3. For example the proxy 3 may provide confirmation to the mobile host by using the registration extension of HIP messaging. The proxy 3 may, in one embodiment, include in the R1 message a parameter that provides information about the proxy services that it is providing for the peer host.

Upon the completion of step 3, therefore, the proxy 3 has been authorised by an end host 1, which is now a peer host to the mobile host, to perform location update signalling on its behalf, the end host has informed the mobile host 2 of this, and the mobile host 2 has confirmed that the proxy 3 does genuinely offer this proxy service.

Steps 1, 2 and 3 may be repeated for other end hosts, with other end hosts authorising a proxy to perform location update signalling on their behalf and informing the mobile host of this. In this case, following completion of step 2, the mobile host 2 knows which end hosts are behind a particular proxy 3 (and in step 3 the mobile host confirms that the proxy 3 does genuinely offer this proxy service for the end host(s) behind the proxy).

According to the invention multiple end hosts may authorise the same proxy to perform location update signalling on their behalf, but it is not necessary for every one of the end hosts to appoint the same proxy nor for every one of the end hosts to appoint a proxy.

When the mobile host 2 makes a hand-off it has to ensure that the end hosts 1 are informed of its new location. When an end host 1 has appointed a proxy 3 to handle location update signalling, the mobile host does not, in the method of the present invention, send a location update message direct to the end host. Instead, the mobile host informs an end host of its new location by sending a location update message to the proxy 3 authorised by the end host, and this is shown as step 4 in FIG. 2. The mobile host knows, from the information received in step 2, which of the end hosts are located behind the proxy 3. (This information may for example be stored in a look-up table which indicates whether end hosts have authorised a proxy and, if so, identifies the proxy that has been authorised.)

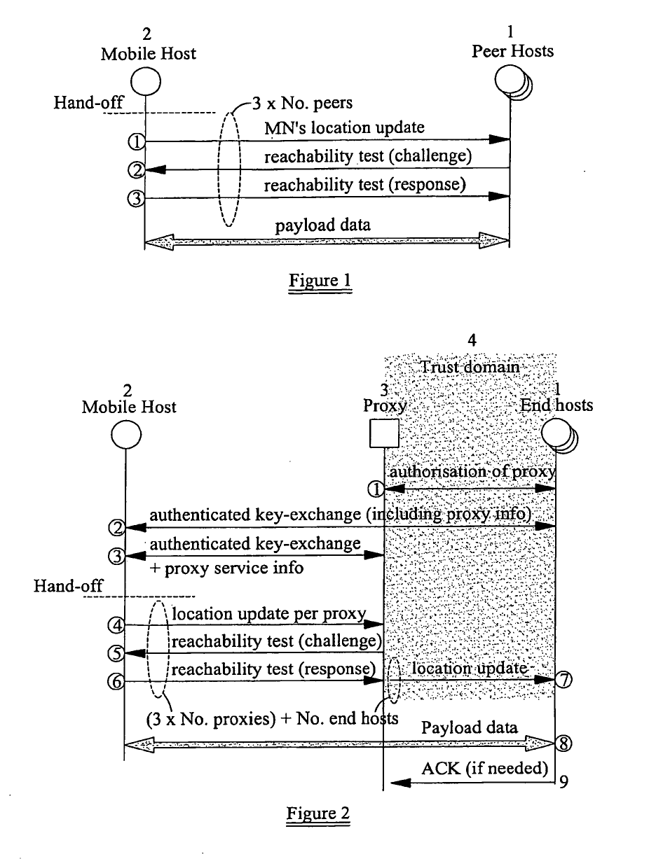

For the reasons explained with reference to FIG. 1, when the proxy 3 receives the location update message from the mobile host 2, it preferably performs a reachability test in order to check that the location update message received from the mobile host is genuine. In the embodiment of FIG. 2, therefore, the proxy 3 sends a reachability test challenge to the new location of the mobile host claimed in the location update message—this is step 5 of FIG. 2. The proxy 3 may sign the reachability test challenge with its private key, and add the authorisation certificate received from the end host to the message.

The mobile host 2 trusts the proxy 3, because the end host 1 has informed the mobile host that it (ie, the end host) has authorised the proxy 3 to run the reachability test on its behalf. Accordingly, when the mobile host 2 receives the reachability test challenge from the proxy 3, it responds by sending a response to the proxy, as shown at step 6 of FIG. 2.

If the response received at the proxy in step 6 is a satisfactory response to the reachability challenge sent in step 5, this indicates that the location update message received from the mobile host is genuine. In this case, the proxy 3 then informs the end host(s) that have authorised the proxy to perform location update signalling of the mobile host's new, verified location. This is step 7 in FIG. 2.

The message sent in steps 4, 5 and 6 may be the same as those in the legacy system of FIG. 1, except for the addition of the proxy authorisation certificate to the reachability challenge message.

The end host(s) 1 may then exchange payload traffic with the mobile host 2 at its new location, and this is shown as step 8 in FIG. 2. The end host(s) send payload traffic to the new location of the mobile node, as advised in the location update message from the proxy, because they have trusted the proxy 3 to run the location update signalling and the reachability on their behalf.

The first outgoing payload traffic sent from a end host 1 to the mobile host 2 serves as an acknowledgement message for the reachability response message sent by the mobile host 2 at step 6. However, if desired, a separate acknowledgement message may be sent from an end host 1, and this is shown as step 9 of FIG. 2. The ACK message is a response to the proxy, so that the proxy knows that the information about the location update of the mobile node has reached the end host. The source address of the message sent in step 7 is the address of the proxy, so that the end host may send the ACK message direct to the proxy.

It can be seen that, when the mobile host is handed-off, it is required to exchange three messages with the proxy 3, in steps 4, 5 and 6 of the method of FIG. 2. The proxy 3 is further required to send a location update message to each end host that has authorised a proxy, at step 7. The total number N of signalling update messages shown in FIG. 2, for the simple case where only one proxy is authorised, is therefore N=3+N_{A}, where N_{A} is the number of end hosts that have authorised the proxy 3.

Although FIG. 2 shows only one proxy 3, it is not necessary for every end host 1 to authorise the same proxy. In general, if there are N_{EH} end hosts, they may authorise a total of Nₚ proxies, where Nₚ≦N_{EH}. The total number N of signalling messages required to advise all end hosts of the location update of the mobile host is N=3Nₚ+N_{EH}.

In the method of FIG. 2, steps 4 to 8, or steps 4 to 9 if the ACK message of step 9 is required, are performed at every hand-off of the mobile host. Steps 1, 2 and 3 are performed once when an end host authorises a proxy to perform location update signalling on its behalf. Steps 1, 2 and 3 do not need to be repeated subsequently, unless an end host wishes to revoke the authorisation of a proxy and authorise another proxy.

In a modified embodiment of the method of FIG. 2, the proxy 3 communicates with a mobile router 5 rather than direct with the mobile host. This modified embodiment is shown schematically in FIG. 3.

In step 1 of FIG. 3 an end host authorises a proxy to perform location update signalling on its behalf. This step corresponds to step 1 of FIG. 2, and its description will not be repeated.

At step 2, the end host 1 informs the mobile host 2 that it has authorised the proxy 3 to perform location update signalling on its behalf. This corresponds to step 2 of the method of FIG. 2.

The method of FIG. 3 preferably includes a step (not shown) corresponding to step 3 of the method of FIG. 2, in which the mobile host 2 verifies that the proxy 3 does indeed provide the proxy services. This step would correspond generally to step 3 of FIG. 2.

In the method of FIG. 3, when the mobile host 2 is handed-off, location update signalling occurs between the mobile host 2 and the proxy 3. FIG. 3 illustrates a method in which the location update signalling includes a reachability test, so that the location update signalling comprises the mobile host 2 sending a location update message to the proxy 3 (step 3), the proxy 3 sending a reachability test challenge to the mobile host (step 4), and the mobile host 2 sending a response to the reachability test (step 4). Provided that the mobile host 2 sends a satisfactory response to the reachability test challenge, the signalling proxy then informs the end host(s) of the new, verified location of the mobile host (step 5). The end host(s) may then send payload traffic to the mobile host at its new location.

Steps 3, 4 and 5 of the method of FIG. 3 correspond respectively to steps 4, 5 and 6, and 7 of the method of FIG. 2, and their description will not be repeated.

If desired, the end host may send an acknowledgment message in response to the location update massage received from the signalling proxy—if present, this would correspond to step 9 of FIG. 2.

The method of FIG. 3 also provides for network mobility in addition to host mobility, by means of a mobile router 5. The mobile router 5 is authorised by the mobile host by an authorisation exchange (step 6).

In the method of FIG. 3, when the mobile router 5 is handed-off, location update signalling occurs between the mobile router 5 and the proxy 3. FIG. 3 illustrates a method in which the location update signalling includes a reachability test, so that the location update signalling comprises the mobile router 5 sending a location update message to the proxy 3 (step 7), the proxy 3 sending a reachability test challenge to the mobile router (step 8), and the mobile router 5 sending a response to the reachability test (step 8). Provided that the mobile router 5 sends a satisfactory response to the reachability test challenge, the signalling proxy then informs the end host(s) of the new, verified location (step 9). The end host(s) may then send payload traffic to the mobile host at its new location.

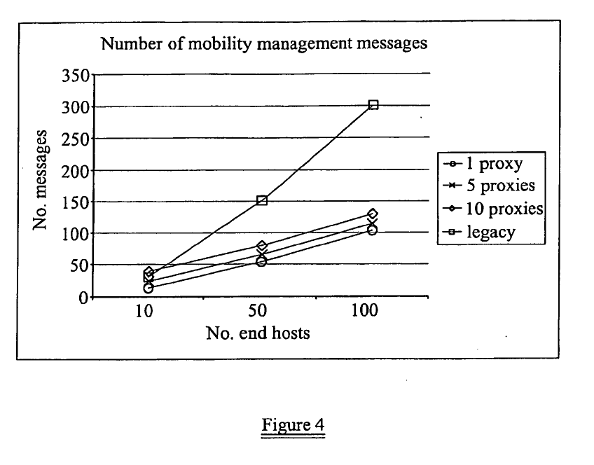

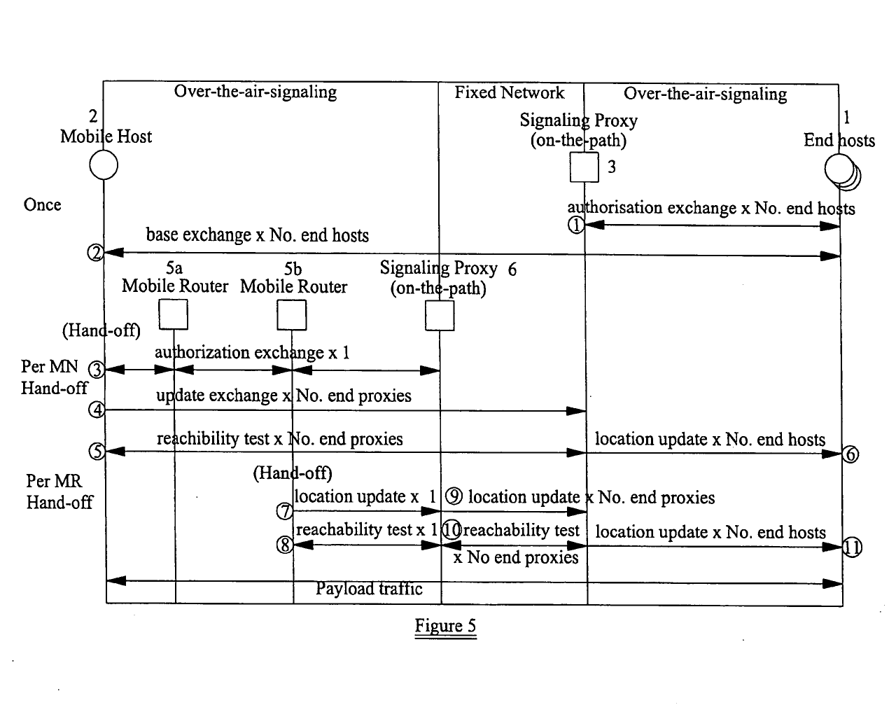

FIG. 4 illustrates the reduction in the number of location update signalling messages that can be obtained by a method of the present invention. In FIG. 4, the data points shown as squares illustrate the number of signalling messages required in the legacy method of FIG. 1, in which 3 signalling messages are required for each end host. The number of signalling messages is therefore three times the number of end hosts.

As explained above, the number of signalling messages required in the method of FIG. 2 or 3 is given by N=3Nₚ+N_{EH}. This is plotted in FIG. 4 for the case of one proxy (data points shown as ∘), five proxies (data points shown as x), and for ten proxies (data points shown as ⋄). It can be seen that, in the case of ten end hosts, the method of the present invention with the use of one proxy or five proxies requires fewer signalling messages than the legacy method of FIG. 1. As the number of end hosts increases, the reduction in the number of signalling messages becomes greater so that, in the case of one hundred end hosts, the method of the present invention with one proxy requires only 103 signalling messages compared to the 300 signalling messages required for the legacy method of FIG. 1. Even if ten proxies are used in the method of the invention the number of signalling messages required for one hundred end hosts is 130, which is still under half the number of messages required by the legacy method of FIG. 1.

In the methods of FIGS. 2 and 3, one or more end hosts 1 authorise a signalling proxy 3 to carry location update signalling on their behalf. The method of the invention may be used in conjunction with a method in which the mobile host also appoints a proxy to handle location signalling, and a method according to this embodiment is shown schematically in FIG. 5.

In the method of FIG. 5, one or more end hosts 1 authorise an end host's side signalling proxy 3 to perform location update signalling, preferably including a reachability test, on their behalf. This is shown as step 1 in FIG. 5, and corresponds to step 1 of FIG. 2.

The mobile host runs an end-to-end update exchange with the end host 1, and this is shown in step 2 of FIG. 5. This corresponds to step 1 of FIG. 2.

Upon hand-off, the mobile host 2 initiates a chain of authorisation exchanges, with the chain starting from the mobile host 2, passing through one or more mobile routers (two mobile routers 5a, 5b are shown in FIG. 5, but the invention is not limited to this particular number) and ending at a mobile host's side signalling proxy 6. This is shown as step 3 in FIG. 5. The update exchanges in step 3 may be, for example, HIP exchanges in which the Host Identity of the signalling proxy 3 at the end host's side is provided to the signalling proxy 6 on the mobile host's side.

When the mobile node is handed-off, it sends a location update message to the end hosts' side signalling proxy 3 (step 4), and the end hosts' side signalling proxy 3 performs a reachability test (step 5). If the results of the reachability test are satisfactory, the end hosts' side signalling proxy 3 informs the end host(s) that have authorised the end hosts' side signalling proxy 3 of the new location of the mobile node (step 6). Step 4 of FIG. 5 corresponds generally to step 4 of FIG. 2, step 5 of FIG. 5 corresponds generally to steps 5 and 6 of FIG. 2, and step 6 of FIG. 5 corresponds generally to step 7 of FIG. 2.

The method of FIG. 5 would preferably include an exchange step (not shown) between the mobile host and the host side signalling proxy 3, to verify that the proxy does provide the proxy services mentioned in the exchange between the end host and mobile node.

When the mobile router 5b is handed-off, it sends a location update message to the mobile host's side signalling proxy 6, and this is shown as step 7 in FIG. 5. The mobile host's side signalling proxy 6 responds to this by performing a reachability test, by sending a challenge message to the new location of the mobile router 5b that is claimed in the location update message. The mobile router 5b sends a response to the challenge message back to the mobile host's side signalling proxy 6. The reachability test between the mobile host's side signalling proxy 6 and the mobile router is shown as step 8 in FIG. 5.

The mobile host's side signalling proxy also sends a location update message to the end hosts' side signalling proxy 3, and this is shown as step 9 in FIG. 5. The mobile hosts' side signalling proxy 3 responds to the location update message by performing a reachability test, by sending a reachability test challenge message to the mobile host's side signalling proxy 6. The mobile host's side signalling proxy 6 sends a response to this challenge message back to the end hosts' side signalling proxy 3. The reachability test between the end hosts' side signalling proxy 3 and the mobile host's side signalling proxy 6 is shown as step 10 in FIG. 5.

The reachability tests of steps 8 and 10 are synchronised such that the mobile host's side signalling proxy 6 does not reply to the challenge message that it receives from the end hosts' side signalling proxy 3 until it has validated the new location of the mobile router 5b—that is, the mobile host's side signalling proxy 6 waits until it has received a satisfactory response to the challenge message that it sent to the mobile router 5b before it responds to the challenge message from the mobile hosts' side signalling proxy 3.

The method of the mobile host 2 appointing the signalling proxy 6 is described in more detail in U.S. provisional patent application No. 60/812,621, U.S. patent application Ser. No. 11/738,819 and PCT application PCT/IB 2007/052091, the disclosure of which is hereby incorporated by reference.

In the method of FIG. 5, steps 4 to 8 are performed at every hand-off of the mobile router. Steps 1 and 3 are performed when an end host authorises a proxy to perform location update signalling on its behalf, and step 2 is performed when a mobile host authorises a proxy to perform location update signalling on its behalf. Steps 1, 2 and 3 do not need to be repeated subsequently, unless an end host or mobile host wishes to revoke the authorisation of a proxy and authorise another proxy.

In the embodiments described above, it has been assumed that the end host(s) are static hosts. The invention is not however limited to this. An end host may be connected to the network by a mobile router, to provide network mobility at the end host side.

1. A method of facilitating location update signalling within a communication network between a mobile node and an end host, the method comprising the steps of:
a) establishing a trust relationship between one or more end hosts and a proxy;
b) performing a location update between a mobile node and the proxy; and
c) sending a location update message from the proxy to end host(s) having the trust relationship with the proxy.

2. A method as claimed in claim 1 wherein step (b) includes the proxy performing a reachability test and wherein step (c) comprises sending the location update message only if the reachability test is concluded successfully.

3. A method as claimed in claim 1 wherein step (a) comprises the proxy being authorised by the end host(s) to perform a reachability test upon their behalf.

4. A method as claimed in claim 1, and comprising the further step of, before the step of performing the location update, the end host(s) informing the mobile host about the trust relationship.

5. A method as claimed in claim 4 wherein the end host(s) inform the mobile host by performing respective key exchanges with the mobile host.

6. A method as claimed in claim 5 wherein the end host(s) provide a public key of the proxy to the mobile host in the key exchanges.

7. A method as claimed in claim 1 and further comprising establishing a security association between the mobile node and the proxy before the step of performing the location update.

8. A method as claimed in claim 2 wherein the proxy provides the mobile node with evidence of its authorisation to perform the reachability test.

9. A method of facilitating location update signalling for a mobile node within a communication network, the method comprising the steps of:
a) receiving, at a proxy, authorisation from one or more end hosts to perform location update signalling on their behalf;
b) receiving, at the proxy, a location update message from a mobile node; and
c) sending a location update message from the proxy to the end host(s).

10. A method as claimed in claim 9 further comprising the proxy, after receiving the location update message, sending a reachability challenge message to the mobile node and wherein step (c) comprises the proxy sending the location update message only if the proxy receives a successful response to the reachability challenge message.

11. A method as claimed in claim 9 and further comprising, before step (b), sending a message from the proxy to the mobile node to establish a security association between the mobile node and the proxy.

12. A method as claimed in claim 9, and comprising the further step of, before step (b), the proxy sending to the mobile node evidence of its authorisation to perform a reachability test.

13. A method of facilitating location update signalling for a mobile node within a communication network, the method comprising the steps of:
a) transmitting, from a end host to a proxy, authorisation for the proxy to perform location update signalling on behalf of the end host;
b) transmitting, from the end host to a mobile node, a message informing the mobile host of the authorisation of the proxy; and
c) receiving, at the end host, a message from the proxy containing a location update for the mobile node.

14. A method as claimed in claim 13 wherein step (b) comprises the end host transmitting a public key of the proxy to the mobile node.

15. A method of facilitating location update signalling for a mobile node within a communication network, the method comprising the steps of:
a) receiving, at a mobile node, notification from a end host that it has authorised a proxy to perform location update signalling on its behalf; and
b) transmitting a location update message from the mobile node to the proxy.

16. A method as claimed in claim 15, and comprising the further step of:
subsequent to step (a) but before step (b), the mobile host initiating a key exchange with the proxy.

17. A method as claimed in claim 1 wherein the mobile node is a mobile host.

18. A method as claimed in claim 1 wherein the mobile node is a mobile router.

19. A proxy for facilitating location update signalling for a mobile node within a communication network, wherein the proxy is adapted to:
a) receive authorisation from one or more end hosts to perform location update signalling on their behalf;
b) receive a location update message from a mobile node; and
c) send, to the end host(s), a message containing a location update for the mobile node.

20. A proxy as claimed in claim 19 wherein the proxy is further adapted to send a reachability challenge message to the mobile host, and wherein the proxy is adapted to send the message containing a location update for the mobile node only if a successful response to the reachability challenge message is received.

21. A proxy as claimed in claim 19 and further adapted to, subsequent to receipt of the authorisation from the end host(s), send a message to the mobile node to establish a security association between the mobile node and the proxy.

22. A proxy as claimed in claim 19, and further adapted to send, to the mobile node, evidence of its authorisation to perform location update signalling on behalf of the end host(s).

23. An end host adapted to:
a) transmit, to a proxy, authorisation for the proxy to perform location update signalling on behalf of the end host;
b) inform a mobile node of the authorisation of the proxy; and
c) receive a location update message from the proxy containing a location update for the mobile node.

24. A host as claimed in claim 23 and adapted to inform the mobile node of the authorisation of the proxy by transmitting a public key of the proxy to the mobile node.

25. A mobile node adapted to:
a) receiving notification from an end host that it has authorised a proxy to perform location update signalling on its behalf; and
b) transmit a location update message to the proxy.

26. A mobile node as claimed in claim 25, and further adapted to:
subsequent to receipt of the notification, initiate a key exchange with the proxy.
